(19) United States
(12) Patent Application Publication
(10) Pub. No.: US 2014/0012404 A1
(43) Pub. Date: Jan. 9, 2014

(54) METHODS AND SYSTEMS FOR MACHINE CUT PLANNING

(71) Applicants: Michael Allen Taylor, Swissvale, PA (US); Timothy Joe Felty, East Peoria, IL (US); Thandava Krishna Edara, Peoria, IL (US)

(72) Inventors: Michael Allen Taylor, Swissvale, PA (US); Timothy Joe Felty, East Peoria, IL (US); Thandava Krishna Edara, Peoria, IL (US)

(73) Assignee: Caterpillar Inc.

(21) Appl. No.: 13/543,174

(22) Filed: Jul. 6, 2012

(51) Int. Cl. G06F 17/50

(52) U.S. Cl. 700/97

(57) ABSTRACT

A system for determining a cut location for a machine implement is disclosed. The system may have one or more memories that store instructions and one or more processors that are capable of executing the instructions. The one or more processors may be configured to select a first potential cut location for a machine implement to begin modifying a work surface, and determine a profile extending from the selected first cut location to an end location along which the machine implement will travel to modify the work surface. The one or more processors may be further configured to calculate a volume of material that will be moved by the machine implement as it travels along the profile, and select, based on the calculated volume of material, a second potential cut location for the machine implement to begin modifying the work surface.

### TECHNICAL FIELD

The present disclosure relates generally to methods and systems for planning cut locations of machines and more particularly, to methods and systems for planning cut locations of machines based on a measurement of a characteristic associated with a particular cut location, such as a volume of material moved, for example.

### BACKGROUND

Machines such as, for example, dozers, motor graders, wheel loaders, etc., are used to perform a variety of tasks. For example, these machines may be used to move material and/or alter work surfaces at a worksite. The machines may be manned machines, but may also be autonomous or semi-autonomous vehicles that perform these tasks in response to commands generated as part of a work plan for the machines. The machines may receive instructions in accordance with the work plan to perform operations such as digging, loosening, carrying, etc., different materials at the worksite.

It may be desirable to ensure that the machines perform these operations such that the materials are moved in an efficient manner. For example, it may be desirable to ensure that the locations at which the machines begin to alter the work surface and/or the profiles along which the machines alter the work surface are chosen such that the machines function efficiently. However, conventional work planning systems may not select these locations and profiles in this manner. Thus, the disclosed control system is directed to overcoming one or more of the problems set forth above and/or other problems present in conventional work planning systems.

### SUMMARY

In one aspect, the present disclosure is directed to a computer-implemented method for determining a cut location for a machine implement. The method may include selecting a first potential cut location for a machine implement to begin modifying a work surface, and determining a profile extending from the selected first cut location to an end location along which the machine implement will travel to modify the work surface. The method may also include calculating a characteristic of a cut made by the machine implement as it travels along the profile, and selecting, based on the calculated characteristic, a second potential cut location for the machine implement to begin modifying the work surface.

In another aspect, the present disclosure is directed to a system for determining a cut location for a machine implement. The system may include one or more memories that store instructions and one or more processors that are capable of executing the instructions. The one or more processors may be configured to select a first potential cut location for a machine implement to begin modifying a work surface, and determine a profile extending from the selected first cut location to an end location along which the machine implement will travel to modify the work surface. The one or more processors may be further configured to calculate a characteristic of a cut made by the machine implement as it travels along the profile, and select, based on the calculated characteristic, a second potential cut location for the machine implement to begin modifying the work surface.

In yet another aspect, the present disclosure is directed to another system for determining a cut location for a machine implement. The system may include a cut location selection module configured to select a first potential cut location for a machine implement to begin modifying a work surface, and a profile calculation module configured to determine a profile extending from the selected first cut location to an end location along which the machine implement will travel to modify the work surface. The system may also include a volume calculation module configured to calculate a volume of material that will be moved by the machine implement as it travels along the profile. The cut location selection module may be further configured to select, based on the calculated volume of material, a second potential cut location for the machine implement to begin modifying the work surface. In certain embodiments, the system may also include a command module configured to generate and send a command to a machine to modify the work surface at a cut location that results in a volume of material moved by the machine implement that is within a predetermined range.

### BRIEF DESCRIPTION OF THE DRAWINGS

FIG. 1 is a pictorial illustration of an exemplary disclosed worksite;

FIG. 2 is a diagrammatic illustration of an exemplary control system that may be used at the worksite of FIG. 1;

FIG. 3 is a pictorial illustration of a simulation of a potential cut at the worksite of FIG. 1 that may be generated by the control system of FIG. 2;

FIG. 4 is a flowchart depicting an exemplary disclosed method that may be performed by the control system of FIG. 2; and

FIG. 5 is a flowchart depicting another exemplary disclosed method that may be performed by the control system of FIG. 2.

### DETAILED DESCRIPTION

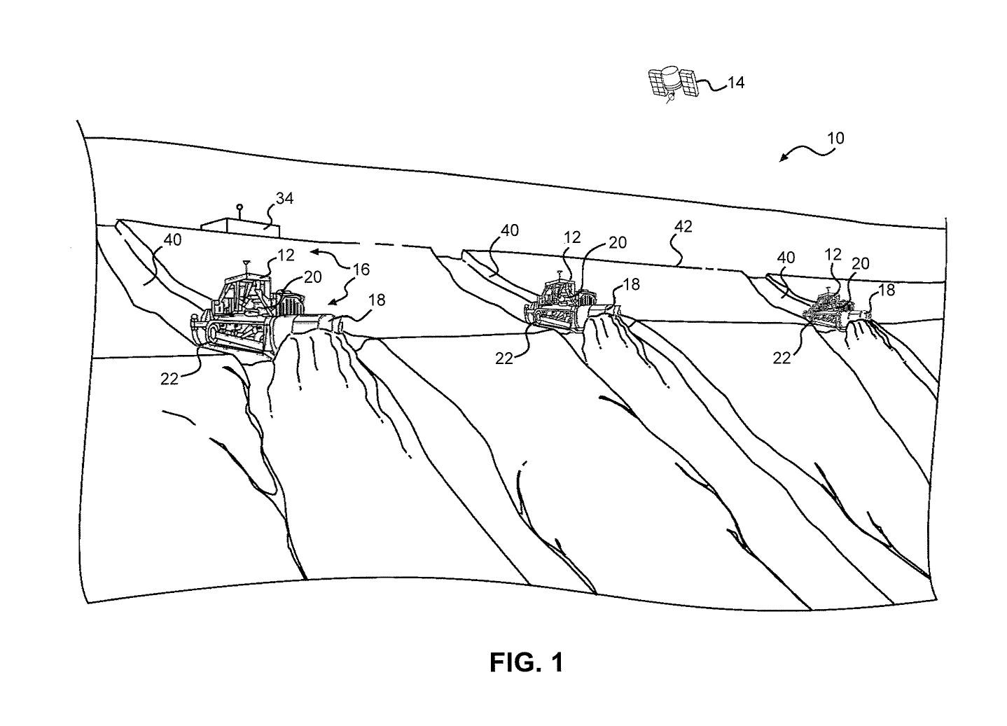

FIG. 1 illustrates a worksite 10 with at least one exemplary machine 12 performing a predetermined task. Worksite 10 may include, for example, a mine site, a landfill, a quarry, a construction site, or any other type of worksite. The predetermined task may be associated with altering the current geography at worksite 10. For example, the predetermined task may include a dozing operation, grading operation, a leveling operation, a bulk material removal operation, or any other type of operation that results in alteration of the current geography at worksite 10. As machine 12 moves about worksite 10, a satellite 14 or other tracking device may communicate with a control system 16 to monitor the movement of machine 12.

Machine 12 may embody a mobile machine that performs some type of operation associated with an industry such as mining, construction, farming, or any other industry known in the art. For example, machine 12 may embody an earth moving machine such as a dozer having a blade or other implement 18 movable by way of one or more motors or actuators 20. Machine 12 may also include one more traction devices 22, which may function to steer and/or propel machine 12. Machine 12 may be a manned machine or any type of autonomous or semi-autonomous machine.

A command center 34 may also be located at the worksite. Command center 34 may also include part of control system 16. Thus, command center 34 may communicate with satellite 14 and/or machine 12 to determine the location and orientation of machine 12 and to send commands to machine 12 to perform tasks.

In certain embodiments, machines 12 may be configured to excavate areas of worksite 10 according to one or more excavation plans. For example, the excavation plans may include, among other things, determining a location, size, and shape of a plurality of cuts into an intended work surface at worksite 10 along a plurality of spaced apart locations known as slots 40. In these embodiments, control system 16 may function as an excavation planner and may be configured to determine a location, size, and trajectory of slots 40 as well as the location, size, and shape of the cuts into the intended work surface at slots 40, as discussed in greater detail below. Of course, other excavation plans that do not utilize slot-based planning may also be used to implement one or more of the disclosed cut planning methods.

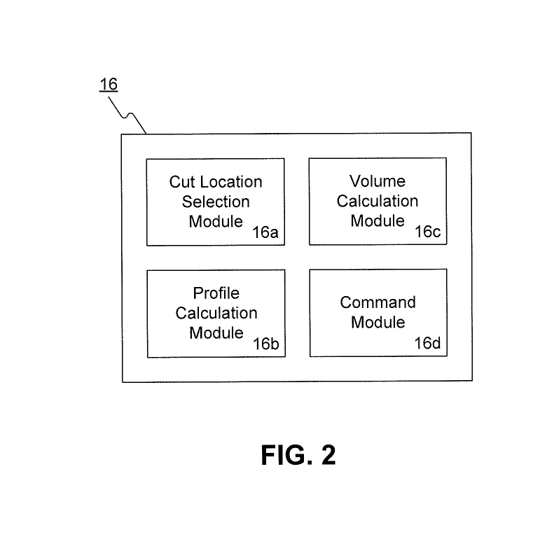

FIG. 2 is a diagrammatic illustration of control system 16 that may be used at worksite 10. As discussed, control system 16 may be located at command center 34 and/or machine 12. In certain embodiments, the functionality of control system 16 may be distributed so that certain functions are performed at machine 12 and other functions are performed at command center 34. In certain embodiments more than one command center 34 may be included and one or more functions may be performed at the multiple command centers.

Control system 16 may include a cut location selection module 16a, a profile calculation module 16b, a volume calculation module 16c, and a command module 16d. These modules may enable control system 16 to select potential cut locations for a machine implement to begin cutting a work surface, simulate the results of cutting at particular potential cut location, and then choose, as a final cut location, one of the potential cut locations that creates the most desirable results, based on one or more criteria, discussed below. In other words, the final cut location may require no further modification and may be the cut location at which control system 16 instructs machine 12 to perform a cut at the work surface. For example, as discussed in greater detail below, cut location selection module 16a may be configured to select a first potential cut location for a machine implement to begin modifying a work surface. Profile calculation module 16b may be configured to determine a profile extending from the cut location selected by cut location selection module 16a to an end location along which the machine implement will travel to modify the work surface. Volume calculation module 16c may be configured to then calculate a volume of material that will be moved by the machine implement as it travels along the profile selected by profile calculation module 16b. Based on the calculated volume of material that will be moved, cut location selection module 16a may then choose a second potential cut location for the machine implement to begin modifying the work surface. This process may be iteratively repeated until cut location selection module 16a selects an acceptable cut location that meets some predetermined criteria, discussed in greater detail below. After cut location selection module 16a selects an acceptable cut location, command module 16d may send a command or a plurality of commands to machine 12 (or to an actuator 20 of machine 12) to make the cut at the acceptable cut location.

While FIG. 2 shows control system 16 as including the separate modules discussed above, those skilled in the art will appreciate that these modules may be implemented as software stored in a memory and/or storage of control system 16 and executed by a processor to enable control system 16 to perform functions consistent with disclosed embodiments. For example, control system 16 may include one or more processors, memories, storages, and input/output interfaces (not shown). The processors may include one or more processing devices, such as microprocessors and/or embedded controllers designed and/or manufactured by one or more of Intel™, AMD™, ARM® Freescale™, Texas Instruments, etc., or any other type of processor. The storage may include a volatile or non-volatile, magnetic, semiconductor, tape, optical, removable, nonremovable, or other type of computer-readable medium or computer-readable storage device. The storage may store programs and/or other information, such as cut planning programs and/or programs used to implement one or more of the modules shown in FIG. 2. The memory may include one or more storage devices configured to store information used by control system 16 to perform certain functions related to disclosed embodiments.

In one embodiment, the memory may include one or more cut planning programs or subprograms loaded from the storage or elsewhere that, when executed by the processor, perform various procedures, operations, or processes consistent with the disclosed embodiments. For example, the memory may include one or more programs that enable control system 16 to, among other things, select a first potential cut location for a machine implement to begin modifying a work surface; determine a profile extending from the selected first cut location to an end location along which the machine implement will travel to modify the work surface; calculate a volume of material that will be moved by the machine implement as it travels along the profile; and select, based on the calculated volume of material, a second potential cut location for the machine implement to begin modifying the work surface. The input/output interfaces of control system 16 may enable control system 16 to send and receive data to and from other devices at worksite 10 or elsewhere, consistent with disclosed embodiments.

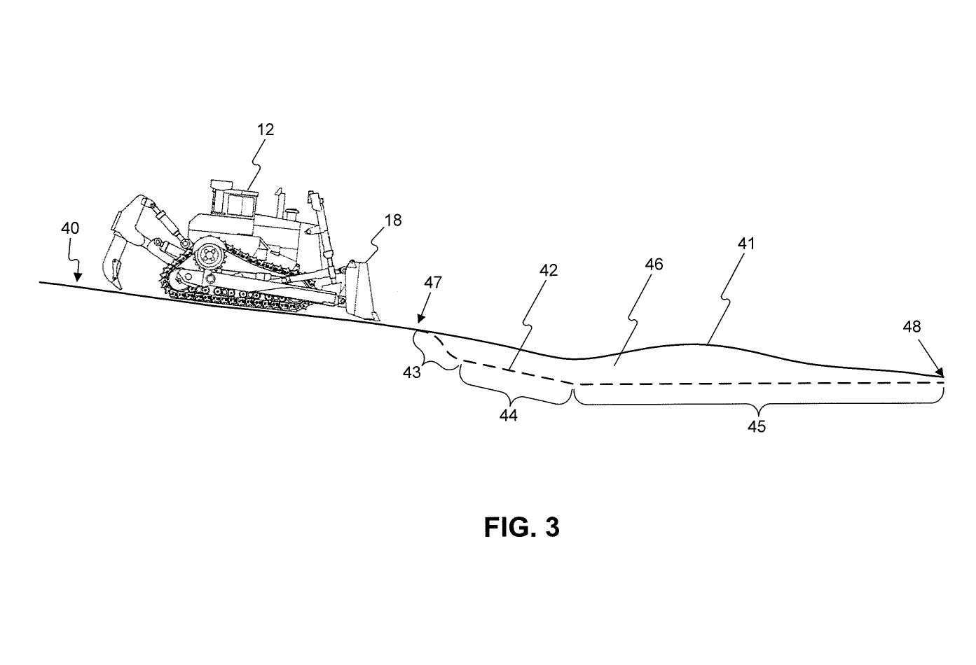

FIG. 3 is a pictorial illustration of a simulation of a potential cut at worksite 10 that may be generated by control system 16. For example, FIG. 3 shows machine 12 with implement 18 located on work surface 41 of slot 40. Work surface 41 represents the height of the existing earth at slot 40. While work surface 41 is shown in two dimensions, those skilled in the art will appreciate that the data representing work surface 41 may be in three dimensions. For example, the data representing work surface 41 may include a plurality of data points that represent the height of work surface 41 at a plurality of locations along work surface 41. This information may be obtained according to any method known in the art. For example, machine 12 may include a global positioning system (GPS) transponder and one or more inertial measurement units (IMUs) and/or accelerometers such that the location, height, and orientation of machine 12 may be detected as it moves about worksite 10. This data may be used to map out the contour of work surface 41 as machine 12 moves across it. This data may also be obtained according to other methods such as by an aerial vehicle that includes lasers and/or cameras and flies over worksite 10.

FIG. 3 also shows a potential cut profile 42 that begins at potential cut location 47 and ends at potential end location 48. As discussed, control system 16 may select cut location 47 and may then generate cut profile 42 based on the cut location. Cut profile 42 may have any shape. For example, FIG. 3 shows cut profile 42 including a first portion 43 that is a Gaussian-shaped portion, a second portion 44 that is a straight, sloped portion, and a third portion 45 that is a straight, level portion. For example, control system 16 may determine the relative lengths, pitches, and depths of these portions based on physical conditions of the work area, such as the length of slot 40, the length of the potential cut, the earth conditions such as rock density, etc. Further, while cut profile 42 is shown in two dimensions, those skilled in the art will appreciate that cut profile 42 is a three dimensional profile. For example, the width of cut profile 42 may correspond to the width of machine implement 18, and the height of cut profile 42 across the remaining two dimensions may correspond to the height of machine implement 18 as it cuts along work surface 41. Moreover, control system 16 may similarly represent cut profile 42 as a plurality of data points that represent the height of cut profile 42 at a plurality of locations in three dimensions. In still other embodiments, control system 16 may not rely on a cut profile 42 and may calculate a volume of material moved by a machine 12 making a cut at cut location 47 in slot 40 without the use of profile 42.

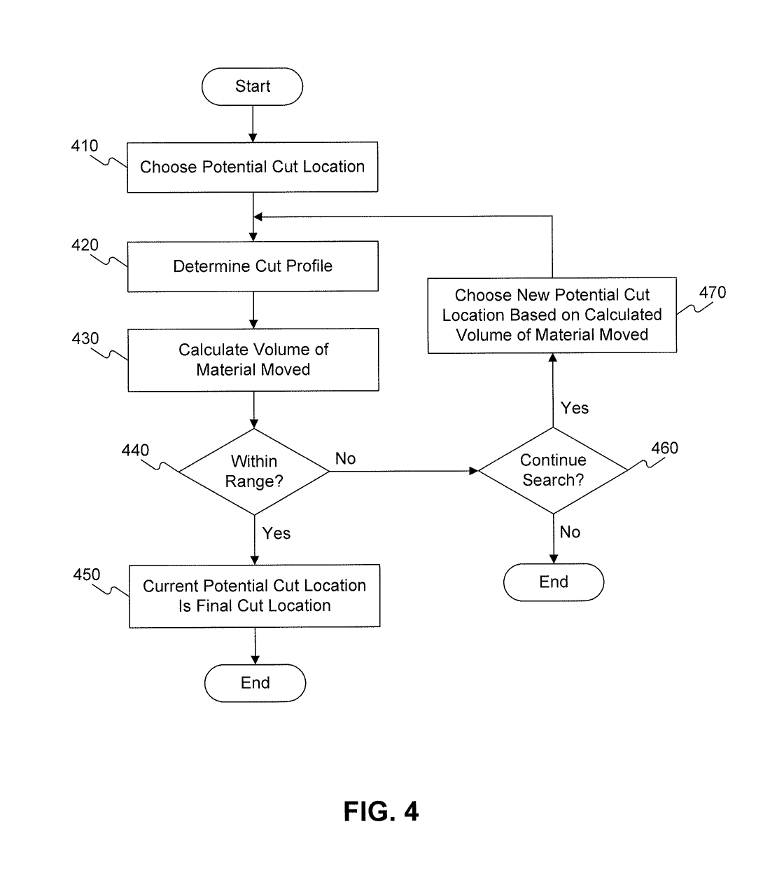

As can be seen from FIG. 3, cutting the work area according to cut profile 42 will result in a volume of material 46 being moved from slot 40. Thus, after determining the shape of cut profile 42, control system 16 may calculate the volume of material 46 that would be moved by implement 18 if machine 12 were to cut along cut profile 42. For example, because control system 16 includes the three-dimensional data that is used to represent both work surface 41 and the resultant surface along cut profile 42, control system 16 may be configured to make a volumetric calculation of the volume of material 46 that will be moved. The calculation of the volume of material 46 to be moved may be used by control system 16 to search for a more ideal cut location, as discussed below with regard to FIG. 4. Moreover, those skilled in the art will appreciate that the exemplary embodiments discussed herein use a volume of material to be moved as an illustration of one particular criteria that may be optimized and that the processes may be used to optimize other criteria, such as, for example, a load on a machine implement, a weight of material to be moved, a smoothness and/or slope of a resultant surface, etc.

FIG. 4 is a flowchart depicting an exemplary disclosed method that may be performed by control system 16 to determine a cut location and cut profile for a machine implement, such as cut location 47 and cut profile 42 shown in FIG. 3. For example, control system 16 may choose a first or initial potential cut location at which implement 18 may begin modifying work surface 41 (step 410). Control system 16 may determine the initial potential cut location in any manner. For example, the initial potential cut location may be entered by a user and/or may be recommended by control system 16, e.g., such that the initial potential cut locations is at a predetermined location of slot 40. For example, control system 16 may choose the initial potential cut location to be at midpoint of slot 40, i.e., a location that is equidistant from a beginning point and an ending point of slot 40.

Based on the initial potential cut location, control system 16 may determine a cut profile, such as cut profile 42, along which implement 18 will travel to modify work surface 41 (step 420). As discussed, the cut profile may take any shape and is not necessarily limited to the shape shown in FIG. 3. Moreover, control system 16 may change the shape of the cut profile for different cut locations. For example, for a particular cut location, control system 16 may determine a corresponding cut profile that varies in depth, length, pitch, etc., from cut profiles corresponding to other cut locations. Moreover, as discussed below, control system 16 may also vary the cut profile at a particular cut location. That is, for a single cut location, control system 16 may vary one or more of the depth, length, pitch, etc., of different sections of the cut profile.

After control system 16 determines the cut profile to be used for the initial potential cut location, control system 16 may calculate the volume of material moved (step 430). For example, as discussed above, because control system 16 includes the three-dimensional data that is used to represent both an existing work surface in slot 40 and the resultant surface along the initial potential cut profile, control system 16 may be configured to make a volumetric calculation of the volume of material that will be moved if implement 18 of machine 12 were to execute a cut along the initial potential cut profile.

Control system 16 may also compare the calculated volume of material moved to a predetermined range of acceptable volumes (step 440). For example, it may be desirable to ensure that machine 12 moves a certain amount of material during each cut. It may be considered inefficient to move less than a certain amount of material (e.g., less than the lower bound of the predetermined range) or to move more than a certain amount of material (e.g., more than the upper bound of the predetermined range). In certain embodiments, the predetermined range may be expressed in relation to the capacity of implement 18. For example, the predetermined range may be 100%-110% of the capacity of machine implement 18. In certain embodiments, the predetermined range may be configurable by a user that is located, e.g., at command center 34 or elsewhere.

If control system 16 determines that the estimated volume of material moved from step 430 is within the predetermined range (step 440, Y), then control system 16 may determine that the current potential cut location (in this case the initial potential cut location) is the final cut location (step 450). In other words, control system 16 may determine that no further modification of the potential cut location is needed and thus the current cut location is the cut location at which machine 12 is to make the cut in the work surface 41. For example, control system 16 may send a command to machine 12 (or actuator 20 of machine 12) to make the cut in the work surface 41 of slot 40 that was selected in step 410. Machine 12 may make the cut in accordance with the command, and then control system 16 may repeat the process shown in FIG. 4 for a subsequent cut in slot 40.

If control system 16 determines that the estimated volume of material move from step 430 is not within the predetermined range (step 440, N), then control system 16 may determine whether it should continue searching by modifying the potential cut location to provide a new cut location that falls within the predetermined range (step 460). For example, control system 16 may be configured to search for a particular cut location using a predetermined number of iterations or for a predetermined period of time. If control system 16 determines that it should not continue to search (step 460, N) then the process may end. In this case, control system 16 may choose a best cut location from among the potential cut locations that were chosen. That is, control system 16 may choose a cut location that yields a volume of material moves that is closest to the predetermined range.

If control system 16 determines that it should continue to search for additional cut locations (step 460, Y), then control system 16 may choose a new potential cut location based on the calculated volume of material moved from step 430 and its comparison to the predetermined range (step 470), and the process may return to step 420 where the process will repeat again for the new potential cut location. Control system 16 may choose the new potential cut location at step 470 in a variety of ways.

In one embodiment, control system 16 may choose the new potential cut location to be a predetermined distance away from the previous cut location in a direction that is determined based on the comparison of the calculated volume of material to the range in step 440. For example, if control system 16 determines that the calculated volume of material is less than a lower bound of the range, then control system 16 may select the new potential cut location to be located a predetermined distance further from the ending location of the slot (in other words, further from end location 48 of the cut in FIG. 3) than the first potential cut location. On the other hand, if control system 16 determines that the calculated volume of material is greater than an upper bound of the range, then control system 16 may select the new potential cut location to be located a predetermined distance closer to the ending location of the slot (in other words, closer to end location 48 in FIG. 3) than the first potential cut location. The predetermined distance may be determined to be a fixed distance value (e.g., 1 meter) or may be determined to be a percentage of the length of the slot (e.g., 5% of the slot length). In certain embodiments, the predetermined distance may be configured and entered by a user, e.g., located at command center 34 or elsewhere.

In another embodiment, control system 16 may choose the new potential cut location by implementing a binary search along the length of slot 40 that is driven by the comparison of the calculated volume of material moved in step 430. That is, control system 16 may search for potential cut locations between the beginning location and the ending location of slot 40 using a binary search. For example, assuming that control system 16 selected the first potential cut location to be equidistant from the beginning and ending locations (i.e., in the middle of slot 40), then if control system 16 determines that the calculated volume of material is less than a lower bound of the range, control system 16 may select the new potential cut location to be located halfway between the current cut location and the beginning location of slot 40. On the other hand, if control system 16 determines that the calculated volume of material is greater than an upper bound of the range, then control system 16 may select the new potential cut location to be located halfway between the current cut location and the ending location of slot 40.

Control system 16 may continue to use the binary search method through additional iterations of the process shown in FIG. 4. For example, assuming that control system 16 selected the first potential cut location to be in the middle of slot 40 and then selected the second potential cut location to be located halfway between the first cut location and the beginning location of slot 40, then control system 16 may continue to use the binary search method to select a third potential cut location. If control system 16 determines that the calculated volume of material for the second potential cut location is less than a lower bound of the range, then control system 16 may select the third potential cut location to be located halfway between the second potential cut location and the beginning location of slot 40. On the other hand, if control system 16 determines that the calculated volume of material is greater than an upper bound of the range, then control system 16 may select the new potential cut location to be located halfway between the second potential cut location and the first potential cut location.

Control system 16 may proceed in this manner by implementing the binary search algorithm until a cut location resulting in a volume of material moved is within the predetermined range. Moreover, while the examples above describe implementing the binary search by cutting the search space in half each time (e.g., a 50% reduction), control system 16 may also implement the binary search method using other percentages, e.g., 40%, 60%, etc. Of course, other searches may be used to select the potential cut locations, e.g., one or more incremental searches, Newton's method-based searches, etc.

After control system 16 selects another cut location according to one or more of the embodiments discussed above (e.g., by moving a predetermined distance, by implementing a binary search algorithm, etc.), control system 16 returns to step 420 where the process repeats for the new cut location. Thus, control system 16 may implement the process in FIG. 4 until a cut location resulting in a volume of material moved is within the predetermined range (step 440, Y) or until control system 16 determines that it should not continue searching for additional cut locations (step 460, N).

In certain embodiments, at step 470, control system 16 may not select a new potential cut location and may instead vary one or more of the depth, length, pitch, etc., of the cut profile. That is, control system 16 may keep the cut location the same, but may vary the shape of the cut profile at that cut location, and then evaluate the volume of material moved for the modified cut profile. For example, if the calculated volume of material moved at step 430 is less than the lower bound of the predetermined range, then control system 16 may generate the new cut profile to be deeper than the previous cut profile.

Additionally, in certain embodiments control system 16 may evaluate other characteristics of a cut location and resulting cut profile in addition to the volume of material moved. For example, control system 16 may evaluate metrics such as the load on the machine implement, the weight of the material moved, smoothness and/or slope of the resultant terrain that will be left behind by a particular cut profile. In one embodiment, at step 440, control system 16 may compare the results of the proposed cut to multiple criteria, such as any combination of volume of material moved, weight of material moved, smoothness and/or slope of the resultant terrain, or any other criteria. Then, at step 470, control system 16 may select a new potential cut location based on the multiple criteria. For example, control system 16 may implement one or more multi-variable optimization algorithms or state space searches using the multiple criteria as variables in order to determine a cut location that optimizes the multiple criteria. That is, instead of implementing a binary search to optimize one criteria or goal, such as the volume of material moved, as described above, control system 16 may implement a multi-variable optimization technique to optimize multiple criteria.

In another embodiment, at step 440, if control system 16 determines that the volume of material moved is within the predetermined range, control system 16 may also evaluate the smoothness and/or slope of the resultant terrain, and may compare these metrics to other thresholds, e.g., representing a minimum desired smoothness or a maximum desired slope. If control system 16 determines that the resultant terrain is not smooth enough or that the slope of the resultant terrain is too steep, then control system 16 may still proceed to step 460 and continue searching for additional cut locations, even though the cut location resulted in a desired volume of material being moved.

In yet another embodiment, at step 440, if control system 16 determines that the volume of material moved is within the predetermined range, control system 16 may also continue to select and evaluate additional potential cut locations, e.g., until an optimized potential cut location is determined. That is, control system 16 may implement one or more optimization algorithms to determine a cut location that most closely matches an optimal volume of material moved, e.g., 100% of the blade load. Thus, in this embodiment, control system 16 may evaluate several potential cut locations that have a volume of material moved within the predetermined range and may choose as the final cut location one of the potential cut locations that most closely matches the optimal volume of material moved.

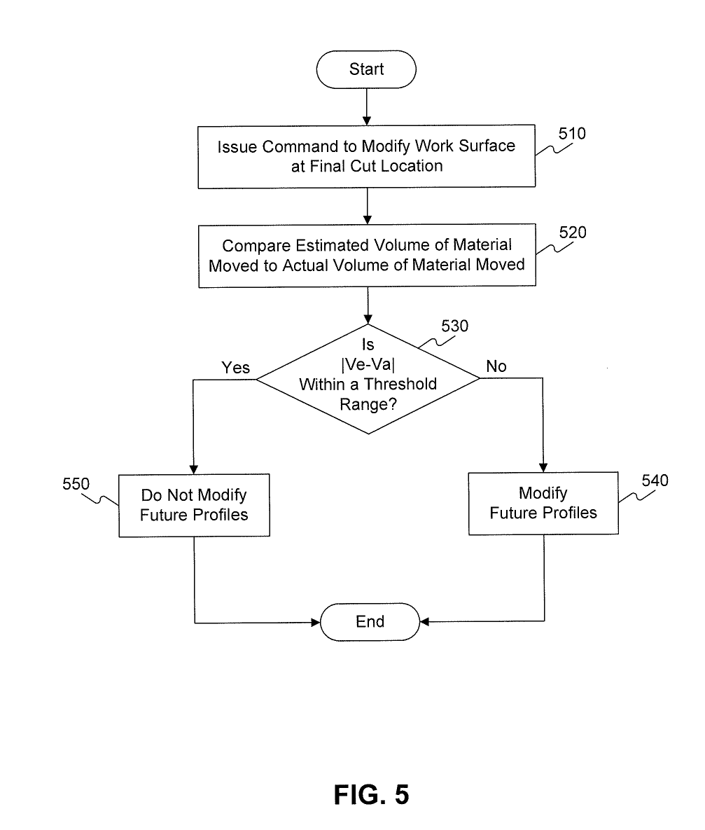

FIG. 5 is a flowchart depicting another exemplary disclosed method that may be performed by control system 16. Control system 16 may execute the process of FIG. 5 in conjunction with that of FIG. 4, for example, to ensure that the cut profiles generated by control system 16 accurately reflect the amount of material moved by implement 18 when machine 12 executes a cut of the work surface. For example, control system 16 may issue a command to machine 12 to modify the work surface at a final cut location (step 510). This final cut location may have been determined, for example, using the process of FIG. 4.

Control system 16 may then compare the estimated volume of material moved for that cut location (e.g., determined at step 430 of FIG. 4) to the actual volume of material moved (step 520). The actual volume of material moved may be calculated in any way consistent with disclosed embodiments. For example, if the density of the material being moved is known, the volume of material moved may be calculated based on the weight of the material moved. In other embodiments, the resultant terrain of the work surface that exists after the cut has been made may be measured in accordance with one or more of the methods discussed above (e.g., using combined GPS and IMU or accelerometer measurements from machine 12, etc.), and the volume of the material moved may be calculated based on a comparison of the work surface before the cut was made to the resultant terrain that exists after the cut was made.

If control system 16 determines that an absolute value of the difference between the estimated volume of material moved and the actual volume of material moved, |Vₑ−Vₐ| is within a threshold value (step 530, Y), then control system 16 may determine that the model generating the cut profiles is accurate and may not modify how future profiles are generated (step 550).

If, on the other hand, control system 16 determines that |Vₑ−Vₐ| exceeds a threshold value (step 530, N), then control system 16 may determine that the model generating the cut profiles is not accurate and may modify how future profiles are generated (step 540). For example, if implement 18 of machine 12 does not load as much material as was expected (e.g., Vₑ>Vₐ), then control system 16 may modify the height of future cut profiles to be deeper than previous cut profiles, so as to move additional material. On the other hand, if implement 18 of machine 12 loads more material than was expected (e.g., Vₐ>Vₑ), then control system 16 may modify the height of future cut profiles to be more shallow than previous cut profiles, so as to move less material.

### INDUSTRIAL APPLICABILITY

The disclosed volume-based cut planning methods and systems may be applicable to machines performing material moving operations where productivity and efficiency is important. Although applicable to any type of machine, the disclosed control system may be particularly applicable to autonomously or semi-autonomously controlled dozing machines that are controlled to excavate materials at a worksite. The disclosed control system may determine locations and/or profiles of cuts in slots at the worksite using a volume-based approach that improves the productivity and efficiency of the machines.

It will be apparent to those skilled in the art that various modifications and variations can be made to the disclosed volume-based cut planning methods and systems. Other embodiments will be apparent to those skilled in the art from consideration of the specification and practice of the disclosed volume-based cut planning methods and systems. It is intended that the specification and examples be considered as exemplary only, with a true scope being indicated by the following claims and their equivalents.

What is claimed is:

1. A computer-implemented method for determining a cut location for a machine implement comprising:
selecting a first potential cut location for a machine implement to begin modifying a work surface;
determining a profile extending from the selected first cut location to an end location along which the machine implement will travel to modify the work surface;
calculating at least one characteristic of a cut made by the machine implement as it travels along the profile; and
selecting, based on the calculated characteristic, a second potential cut location for the machine implement to begin modifying the work surface.

2. The computer-implemented method according to claim 1, wherein the calculated characteristic is a volume of material that will be moved by the machine implement as it travels along the profile.

3. The computer-implemented method according to claim 2, wherein selecting the second potential cut location further includes:
comparing the calculated volume of material from the first potential cut location to a volume of material range;
selecting the second potential cut location to be located further from the end location than the first potential cut location if the calculated volume of material is less than a lower bound of the volume of material range; and
selecting the second potential cut location to be located closer to the end location than the first potential cut location if the calculated volume of material is greater than an upper bound of the volume of material range.

4. The computer-implemented method according to claim 3, further including:
selecting the second potential cut location using a binary search algorithm.

5. The computer-implemented method according to claim 2, further including
comparing the calculated volume of material from the first potential cut location to a volume of material range; and
selecting the second potential cut location to be a predetermined distance further from the end location than the first potential cut location in response to determining that the calculated volume of material is less than a lower bound of the volume of material range.

6. The computer-implemented method according to claim 2, further including
comparing the calculated volume of material from the first potential cut location to a threshold volume of material range; and
selecting the second potential cut location to be located a predetermined distance closer to the end location than the first potential cut location in response to determining that the calculated volume of material is greater than an upper bound of the volume of material range.

7. The computer-implemented method according to claim 2, wherein calculating the volume of material further includes:
determining a profile of the work surface; and
calculating the volume of material that will be removed by comparing the profile of the work surface to the profile along which the machine implement will travel to modify the work surface.

8. The computer-implemented method according to claim 2, further comprising:
selecting a final potential cut location;
calculating an estimated volume of material that will be moved by the machine implement as it travels along a profile associated with the final potential cut location; and
determining that the estimated volume of material moved is within a threshold volume of material range; and
sending one or more commands to a machine to modify the work surface according to the profile associated with the final potential cut location.

9. The computer-implemented method according to claim 8,
calculating an actual volume of material that was moved by the machine implement after modifying the work surface according to the profile associated with the final potential cut location;
comparing the actual volume of material to the estimated volume of material; and
adjusting future profiles corresponding to future modifications of the work surface if a difference between the actual volume of material and the estimated volume of material is outside of a threshold range.

10. The computer-implemented method according to claim 9, wherein adjusting the future profiles includes changing a height of at least a portion of the future profiles.

11. A system for determining a cut location for a machine implement comprising:
one or more memories storing instructions; and
one or more processors capable of executing the instructions and configured to:
select a first potential cut location for a machine implement to begin modifying a work surface;
determine a profile extending from the selected first cut location to an end location along which the machine implement will travel to modify the work surface;
calculate at least one characteristic of a cut made by the machine implement as it travels along the profile; and
select, based on the calculated characteristic, a second potential cut location for the machine implement to begin modifying the work surface.

12. The system according to claim 11, wherein the calculated characteristic is a volume of material that will be moved by the machine implement as it travels along the profile.

13. The system according to claim 12, the one or more processors being further configured to:
compare the calculated volume of material from the first potential cut location to a volume of material range;
select the second potential cut location to be located further from the end location than the first potential cut location if the calculated volume of material is less than a lower bound of the volume of material range; and
select the second potential cut location to be located closer to the end location than the first potential cut location if the calculated volume of material is greater than an upper bound of the volume of material range.

14. The system according to claim 13, the one or more processors being further configured to select the second potential cut location using a binary search algorithm.

15. The system according to claim 12, the one or more processors being further configured to:
compare the calculated volume of material from the first potential cut location to a volume of material range; and
select the second potential cut location to be a predetermined distance further from the end location than the first potential cut location in response to determining that the calculated volume of material is less than a lower bound of the volume of material range.

16. The system according to claim 12, the one or more processors being further configured to:
compare the calculated volume of material from the first potential cut location to a threshold volume of material range; and
select the second potential cut location to be located a predetermined distance closer to the end location than the first potential cut location in response to determining that the calculated volume of material is greater than an upper bound of the volume of material range.

17. The system according to claim 12, the one or more processors being further configured to:
determine a profile of the work surface; and
calculate the volume of material that will be removed by comparing the profile of the work surface to the profile along which the machine implement will travel to modify the work surface.

18. The system according to claim 12, the one or more processors being further configured to:
select a final potential cut location;
calculate an estimated volume of material that will be moved by the machine implement as it travels along a profile associated with the final potential cut location; and
determine that the estimated volume of material moved is within a threshold volume of material range; and
send one or more commands to a machine to modify the work surface according to the profile associated with the final potential cut location.

19. The system according to claim 18, the one or more processors being further configured to:
calculate an actual volume of material that was moved by the machine implement after modifying the work surface according to the profile associated with the final potential cut location;
compare the actual volume of material to the estimated volume of material; and
adjust future profiles corresponding to future modifications of the work surface if a difference between the actual volume of material and the estimated volume of material is outside of a threshold range.

20. A system comprising:
a cut location selection module configured to select a first potential cut location for a machine implement to begin modifying a work surface;
a profile calculation module configured to determine a profile extending from the selected first cut location to an end location along which the machine implement will travel to modify the work surface; and
a volume calculation module configured to calculate a volume of material that will be moved by the machine implement as it travels along the profile, wherein
the cut location selection module is further configured to select, based on the calculated volume of material, a second potential cut location for the machine implement to begin modifying the work surface.
